(19) United States
(12) Patent Application Publication
(10) Pub. No.: US 2022/0122091 A1
(43) Pub. Date: Apr. 21, 2022

(54) SYSTEM AND METHOD FOR RETURN FRAUD DETECTION AND PREVENTION

(71) Applicant: Coupang Corp., Seoul (KR)

(72) Inventor: Taehyun AN, Gyeonggi-do (KR)

(73) Assignee: Coupang Corp.

(21) Appl. No.: 17/075,763

(22) Filed: Oct. 21, 2020

(51) Int. Cl. G06Q 30/00; G06Q 10/08; G06Q 20/40

(52) U.S. Cl. CPC G06Q 30/0185; G06Q 10/0837; G06Q 30/016; G06Q 20/4016; G06Q 20/405; G06Q 20/407

(57) ABSTRACT

A computer-implemented systems and methods for return fraud detection and prevention are disclosed. The computer-implemented system may comprise a memory storing instructions and at least one processor. The at least one processor may be configured to receive a refund request from a device, identify a content status from a return package, and associate the refund request with the content status, determine a customer associated with the refund request and the content status, aggregate a profile of the customer from the refund request, the device, and the content status, assign a refund status and a fraudulent member status associated with the refund request from at least one rule definition and the profile of the customer, determine an approval or rejection of the refund request from the refund status, the fraudulent member status, and at least one business rule, and provide the device with the approval or rejection of the request refund.

### TECHNICAL FIELD

The present disclosure generally relates to computerized systems and methods for refund requests evaluation and blocking. In particular, embodiments of the present disclosure relate to inventive and unconventional systems and methods for detecting and stopping fraudulent refunds.

### BACKGROUND

Fulfillment companies currently may experience large numbers of abuse by customers that may request refunds for orders that customers either keep under the false pretense that the orders are spoiled or have been returned back to the fulfillment companies or their sellers. Some customers claim that an order was returned but after long investigations, the fulfillment company discovers that a package was returned; however, the package is empty or partially filled with some of the items from the order(s). These investigations associated with fraudulent refund request may cost a lot of resources and capital to fulfillment companies, which may deter and prevent fulfillment companies from competing in providing superior customer service to its customers. In addition, customers who actively make fraudulent refund requests may use different modes of communication with the fulfillment companies in order to hide their true identity so that the fulfillment companies may not recognize those customers as repeat offenders abusing refund requests. These repeat abusers of refund request also may cost a lot of resources and capital to the fulfillment companies because they may be unable to detect those abusers.

To attempt to overcome the problem of customers associated with fraudulent refund requests, fulfillment companies may have coordinated their efforts with sellers to minimize confusion regarding customers making claims that orders were returned to either the fulfillment companies or the sellers. Other fulfillment companies may have completely opted out of competing for superior customer service when it comes to refund requests. Furthermore, fulfillment companies may have attempted to curtail the amounts of abusive and fraudulent refund requests by setting a long lead-time to award a refund to a customer in the hope that the delay may deter abuser from seeking to make fraudulent refund requests.

Moreover, some fulfillment companies may have attempted to tackle the problem of customers associated with fraudulent refund requests and their abusive and fraudulent refund requests by putting in place systems that may automate the investigation process. However, the automation of current systems may be fraught with problems because current systems may be unable to cope with communication disruptions between the customers and the current systems. The disruptions in communication between the customers and the fulfillment companies with current systems may negatively impact the fulfillment center's customer service regarding refund requests because customers may have to initiate additional calls to start from scratch the process of requesting a refund.

Another deficiency with current systems is their inability to properly identify a customer that assumes multiple identities to replicate their fraudulent refund requests. This inability for current systems to detect a customer with multiple identities ends up costing more than the current systems, which may defeat the purpose of those current systems as customers know that current systems may not detect multiple identities by the same customer.

Still yet another issue that fulfillment companies may find with current systems may be their inability to integrate with the sellers systems or their own legacy systems. This lack of ability to integrate may cause the fulfillment companies delays or lack of effective investigations of customers associated with fraudulent refund requests or fraudulent refund requests because of loss in communication between the sellers systems, the current systems, and the fulfillment legacy systems. The current systems may not be versatile enough to easily integrate with legacy systems in order to provide a superior customer service experience for refund requests, which may require long lead-times for integration and tests to fix all possible issues regarding the integration of current and legacy systems.

Yet another issue with current systems may be the inability for a lay person to change rules in determining the definition for a customer associated with fraudulent refund requests or abusing refund requests. Current systems may require that the rules used for investigations be hardcoded where people of expertise in the area of computer programming may be required for such change. The requirement of using a computer programmer to change the code relating to rules of investigating customers associated with fraudulent refund requests and their fraudulent refund requests may demonstrate the inability of current systems to be adapted to changing needs according to market forces or changes. Fulfillment companies may be left with no remedies to quickly adapt and compete with changing market demands in the customer service of refund requests. Therefore, if, for example, a product is known to be defective, current systems require a total revamping of its code to be able to deal with legitimate refund requests from customers even if some customers are associated with fraudulent refund requests. The inability of current systems to be easily upgraded in a very short amount of time by a lay person, such as a business person, to quickly respond to market demands may also cost fulfillment companies their goodwill with customers.

Therefore, there is a need for improved methods and systems to detect customers associated with fraudulent refund requests and their fraudulent refund requests with no loss of communication with the customer or with its own systems, proper detection of customers' identities with multiple alias, and ease of investigative rules change by laypersons to adapt to changing market demands.

### SUMMARY

One aspect of the present disclosure is directed to a computer-implemented system for return fraud detection and prevention. The computer-implemented system may comprise a memory storing instructions and at least one processor configured to execute the instructions to receive a refund request associated with an order id from a device, identify a content status associated with a return package associated with the order id from the device, and associate the refund request associated with the order id with the content status associated with the return package. Furthermore, the at least one processor may be configured to determine a customer associated with the refund request and the content status, aggregate a profile of the customer based on the refund request, the device, and the content status, assign a refund status and a fraudulent member status associated with the refund request of the customer based on at least one rule definition and the profile of the customer. Moreover, the at least one processor may be configured to determine an approval or rejection of the refund request based on the refund status, the fraudulent member status, and at least one business rule and provide the device of the customer with the approval or rejection of the request refund.

Another aspect of the present disclosure is directed to a computer-implemented system return fraud detection and prevention. The computer-implemented system may comprise a memory storing instructions and at least one processor configured to execute the instructions to receive a refund request associated with an order id from a device, determine a customer associated with the refund request, aggregate a profile of the customer based on the refund request and the device, assign a refund status and a fraudulent member status associated with the refund request of the customer based on at least one rule definition and the profile of the customer. Moreover, the at least one processor may be configured to determine an approval or rejection of the refund request based on the refund status, the fraudulent member status, and at least one business rule and provide the device of the customer with the approval or rejection of the request refund.

Yet another aspect of the present disclosure is directed to a computer-implemented method for return fraud detection and prevention. The computer-implemented method may comprise the steps of receiving a refund request associated with an order id from a device, identifying a content status associated with a return package associated with the order id from the device, and associating the refund request associated with the order id with the content status associated with the return package. Furthermore, the method may comprise determining a customer associated with the refund request and the content status, aggregating a profile of the customer based on the refund request, the device, and the content status, assigning a refund status and a fraudulent member status associated with the refund request of the customer based on at least one rule definition and the profile of the customer. Moreover, the method may comprise determining an approval or rejection of the refund request based on the refund status, the fraudulent member status, and at least one business rule and providing the device of the customer with the approval or rejection of the request refund.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3A illustrates an exemplary pictographic representation of an intake sub-system 300, consistent with the disclosed embodiments.

FIG. 3B illustrates an exemplary pictographic representation of an output sub-system 325, consistent with the disclosed embodiments.

FIG. 3C illustrates a pictographic representation of an exemplary control sub-system, an exemplary returns event store, an exemplary rule engine, and exemplary external data sources, consistent with disclosed embodiments.

FIG. 3D illustrates an exemplary pictographic representation of a workflow sub-system 375, consistent with the disclosed embodiments.

FIG. 4 is a block diagram illustrating an exemplary system 400 for fraud detection and customer abuse, consistent with the disclosed embodiments.

FIG. 5 is a flow chart of an exemplary method 500 of determining a content status for a return package, consistent with the disclosed embodiments. Processor 402 may receive the return package

FIGS. 6A and 6B are flow charts of an exemplary method 600 of determining a refund status and a member status based on rule definitions for retail goods or fresh food products, consistent with the disclosed embodiments.

FIGS. 7A and 7B are flow charts of an exemplary method 700 of determining a final refund status or a final member status based on business rules for retail goods or fresh food products, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured to maintain communication with customers and the fulfillment companies' systems to minimize disruptions and the time in processing and investigating refund requests by using asynchronous communication systems and application programming interface for integration with foreign systems—such as sellers or legacy systems—to provide for the implementation of backup redundancies between the systems.

Furthermore, embodiments of the present disclosure are directed to systems and methods configured to detect customers with multiple aliases or identities in order to continue to proliferate fraudulent refund requests where, for example, a customer may use a different user name or sign up id, a different device, a different name, or a different physical address.

Moreover, embodiments of the present disclosure are directed to systems and methods configured to easily change rule definitions for investigating customers associated with fraudulent refund requests and their abusive and fraudulent refund requests by implementing a virtual interface, which may allow laypersons to create new rules to determine customers associated with fraudulent refund requests and their abusive and fraudulent refund requests. The implementation of the virtual interface allowing layperson to create new rules may allow the fulfillment company to quickly respond to market forces in the customer service of refund requests.

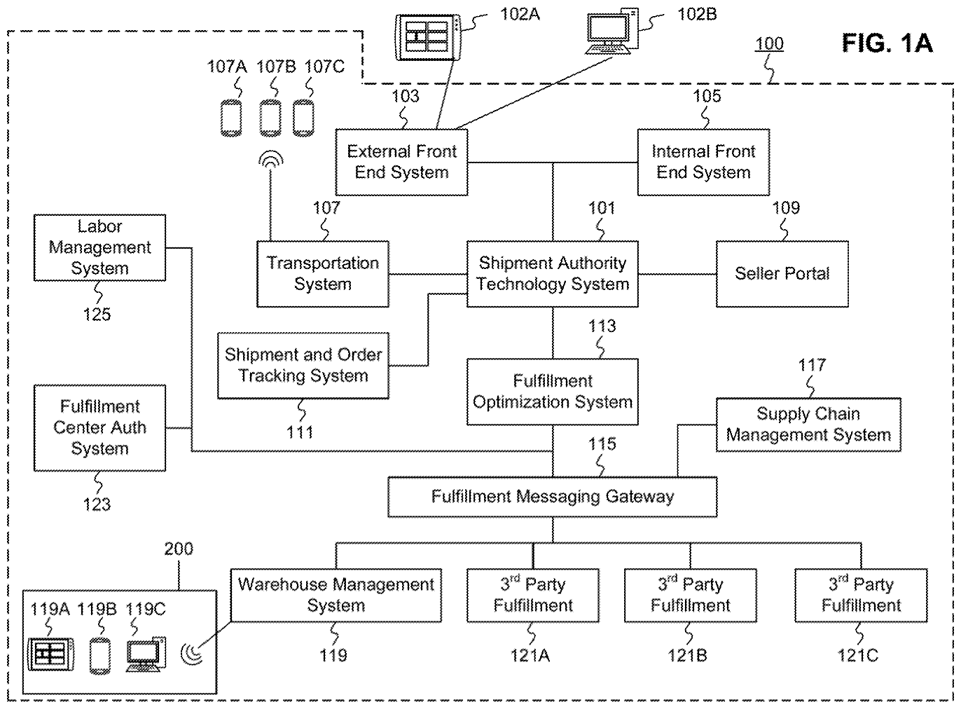

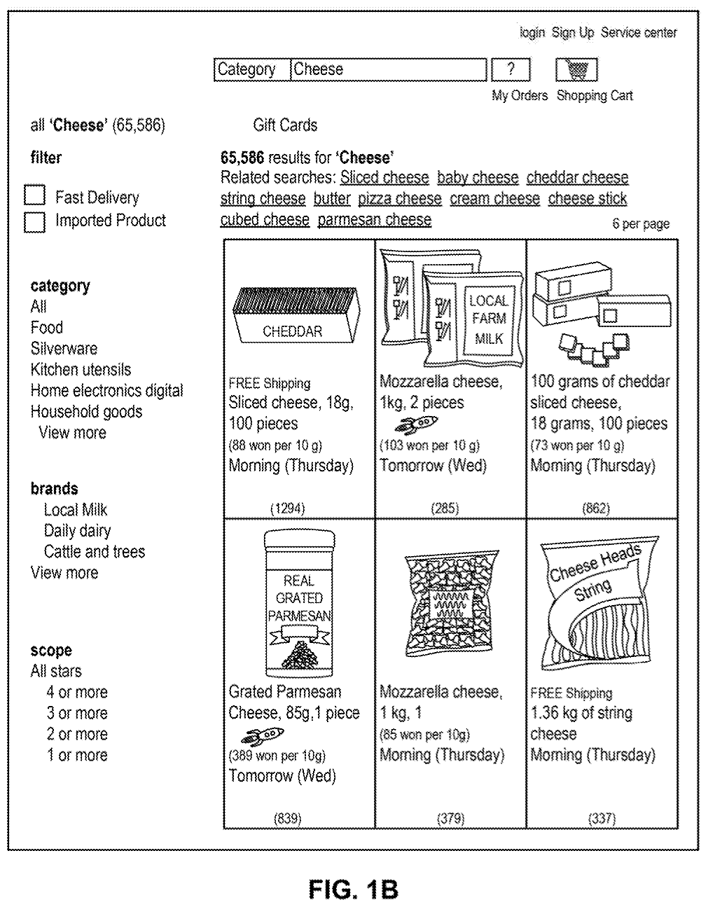

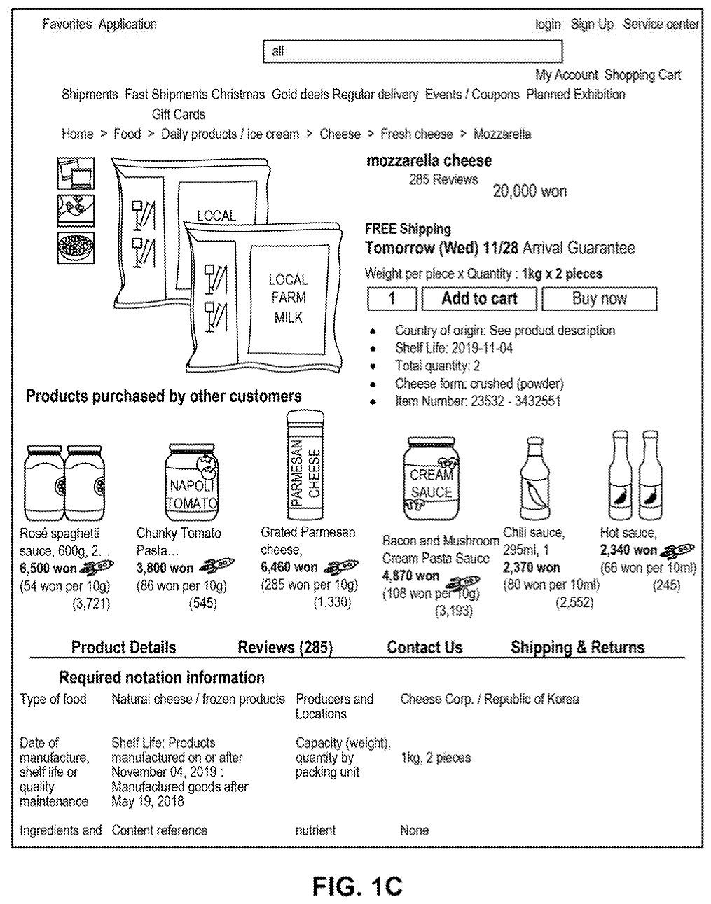

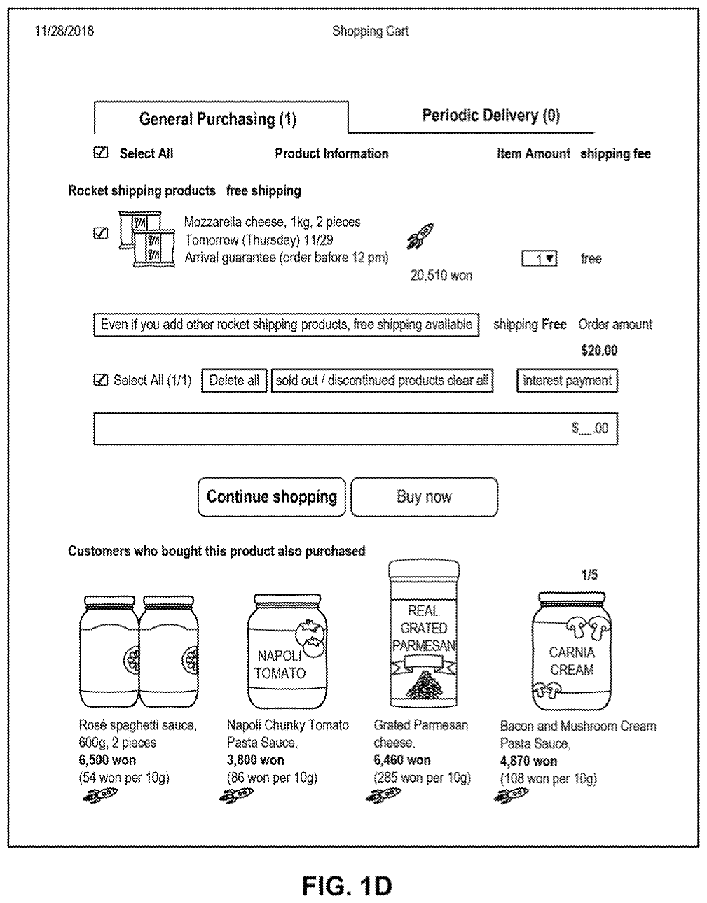

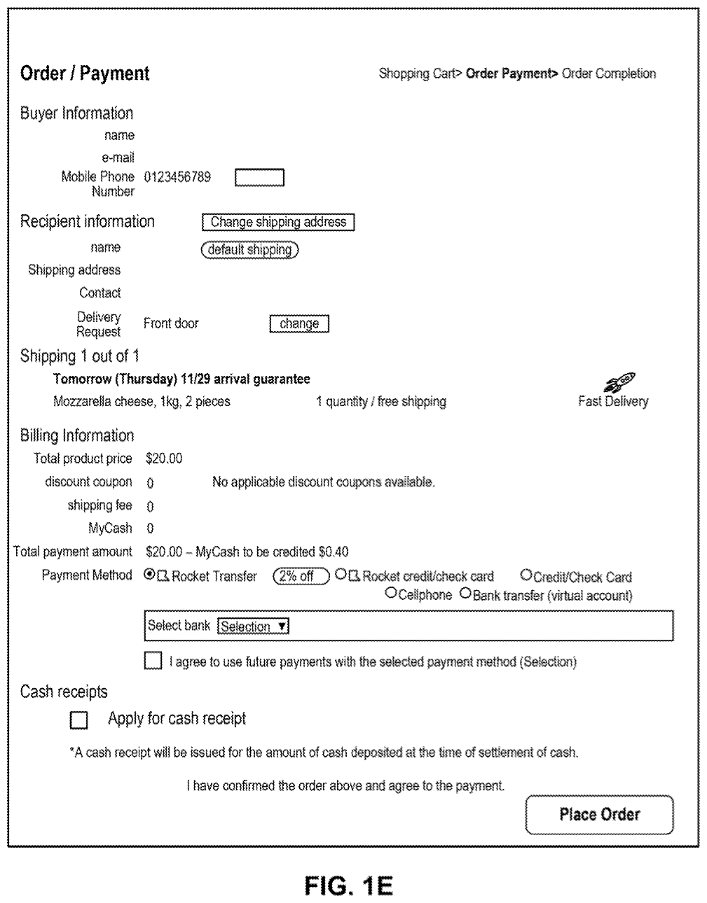

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 1198, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

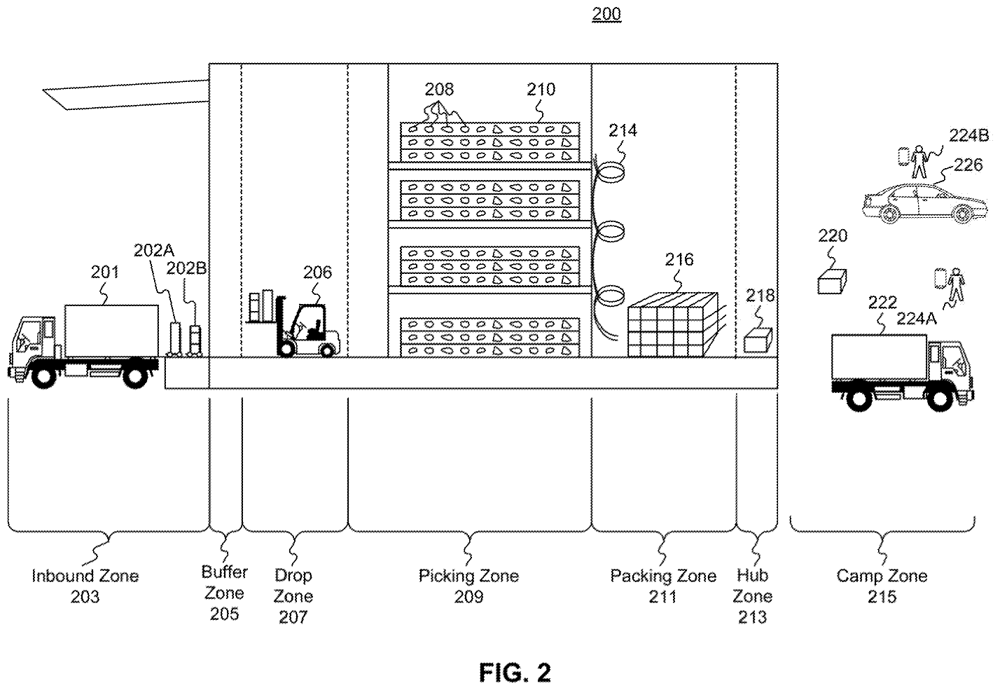

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

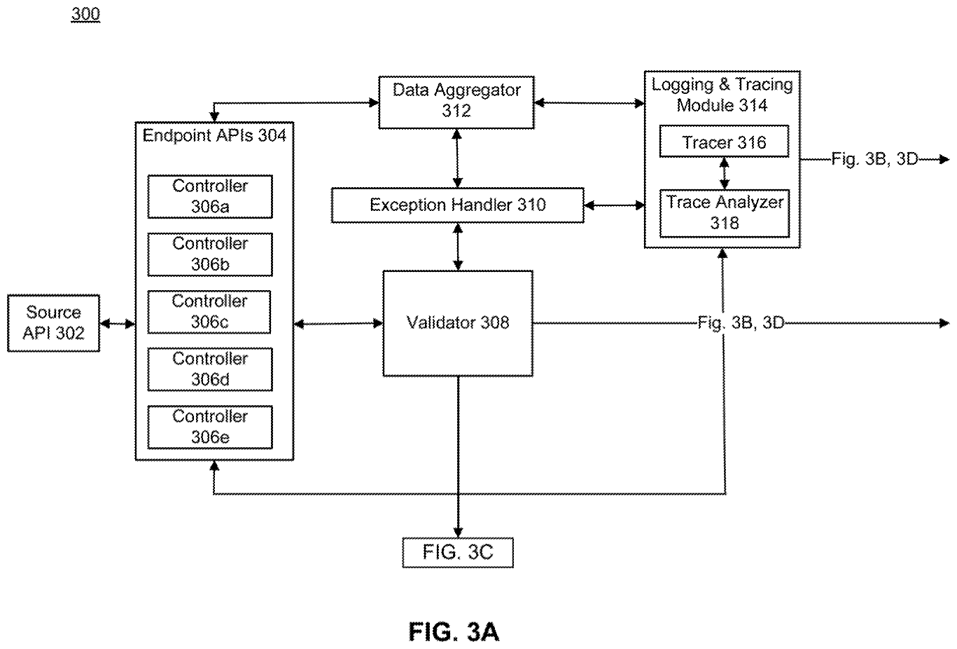

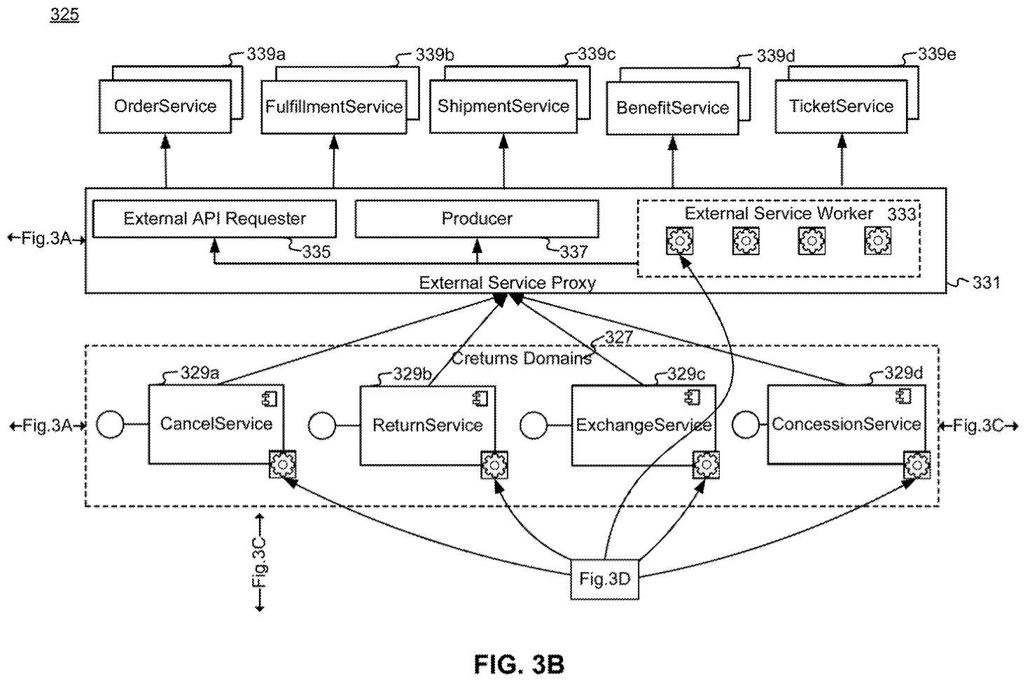

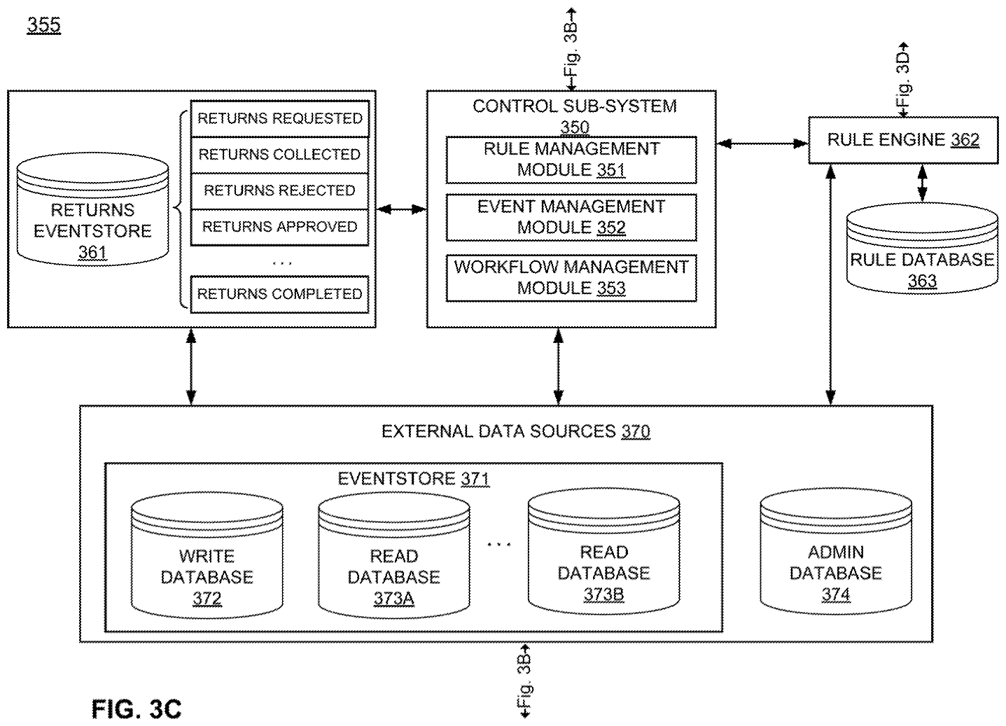

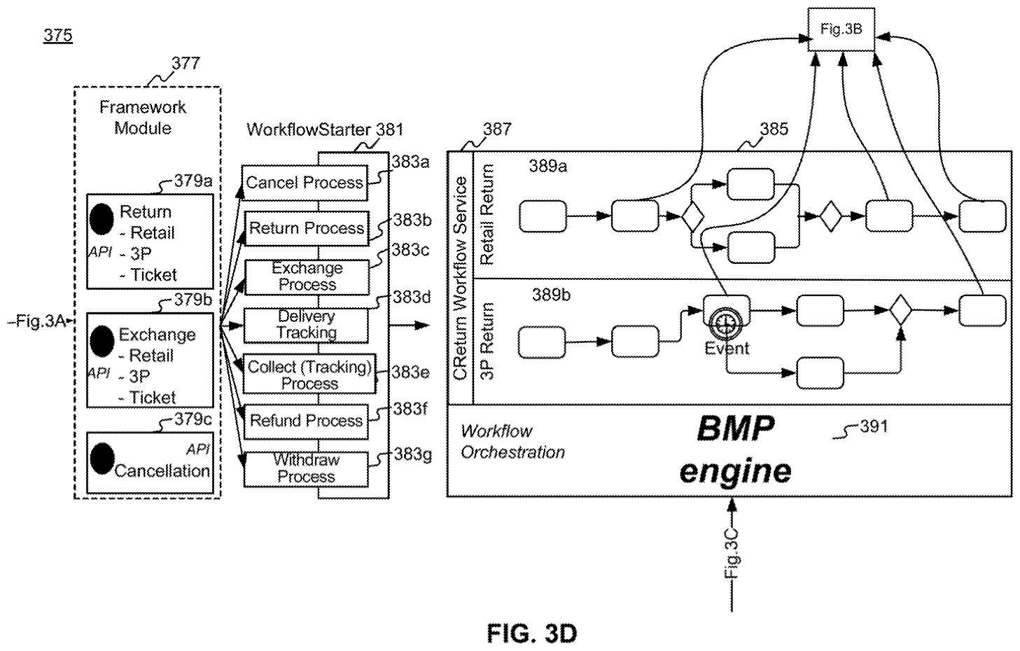

FIG. 3A illustrates an exemplary pictographic representation of an intake sub-system 300. Intake sub-system 300 may be designated for initial processing of a communication from a source application program interface (API) 302. Source API 302 may be any one of a number of APIs, which may be specifically configured for use by a consumer, a delivery-person, an administrator, and/or a seller. Source API 302 may be implemented on a computing device having a processor, memory component, and/or communications component, such as a mobile device, a desktop computer, an adapter, a controller, a server, or any other device capable of sending and/or receiving API communications. In some embodiments, intake sub-system 300 and/or components of intake sub-system 300 may be communicably coupled to other sub-systems (e.g., as described in FIGS. 3B-3D).

Intake sub-system 300 may also include a number of endpoint APIs 304, to which source API 302 may be communicably coupled. In some embodiments, endpoint APIs 304 may only be a single endpoint API. Endpoint APIs 304 may include a plurality of controllers, adapters, and/or other computing devices, which may be managed by an API provider (not shown). For example, endpoint APIs 304 may be implemented by a combination of controllers, such as controller 306a, controller 306b, controller 306c, controller 306d, and/or controller 306e. In some embodiments, a controller may be designated for handling operations for a particular entity (e.g., a seller). A controller may be a hardware device or a software program, which may manage dataflows between different entities (e.g., between source API 302 and data aggregator 312). For example, a controller may be, without limitation, a flash controller, an application delivery controller, a primary domain controller, a baseboard management controller, and/or a session border controller. In some embodiments, a communication from source API 302 may be directed to a specific endpoint API or controller based on a source associated with the communication. For example, an API provider may receive a communication from a source API 302 and may determine (e.g., based on a message identifier, IP address, MAC address, communication format, and/or other unique identifier) a source and/or type of the communication. Based on the identified communication source and/or communication type, the API provider may direct the communication to a particular controller, which may be configured for communications of having a particular source and/or type. By way of further example, API provider may determine that a communication from source API 302 has a consumer device as its communication source and a return request as its communication type, and may direct the communication to an endpoint API 304 (e.g., controller 306b), which may be configured for handling communications having a source and/or type of the received communication (e.g., configured for return request communications).

Intake sub-system 300 may also include a validator 308, which may validate communications from a source API 302, and may be communicably coupled to endpoint APIs 304. Validator 308 may exist within an endpoint API 304 (e.g., as part of a controller), or may exist as a separate component, such as a server, to which an endpoint API 304 may be connected. Validator 308 may include various components (e.g., modules, devices, processors, etc.) configured to carry out a validation process (e.g., a process for validating communications received from a source API 302). For example, validator 308 may include a validator invoker, a validation pre-processor (e.g., for re-formatting data from a communication), a validator processor (e.g., for performing validation operations to data), a validator post-processor (e.g., for re-formatting validated data to a format understandable by another entity, such as rule engine 362 in FIG. 3C), a validation manager, and/or a message publisher (which may direct messages to another sub-system).

Intake sub-system 300 may also include an exception handler 310, to which validator 308 may be communicably coupled. Exception handler 310 may be part of validator 308, or may be a separate device or component, such as a server or mobile device. In some embodiments, validator 308 may direct a communication to exception handler 310 based on a validation result of a communication, which may have been determined by validator 308. For example, if a communication fails at least one rule or algorithm implemented by validator 308, validator may direct the communication to exception handler 310. In some embodiments, exception handler 310 may be configured re-format, split, parse, tag, and/or otherwise re-configure or transmit information from the communication (e.g., issuing an alert to an administrator device) based on the at least one rule or algorithm failed by the communication. Exception handler 310 may be communicably coupled to a data aggregator 312 and/or a logging & tracing module 314.

Intake sub-system 300 may also include a data aggregator 312, which may aggregate data from different sources, such as endpoint APIs 304, exception handler 310, and/or logging & tracing module 314. Data aggregator 312 may be communicably coupled to any device and/or component of sub-system 300, as well as devices and/or components of other systems including sub-systems 325 in FIG. 3B, 355 in FIG. 3C, and 375 in FIG. 3D. Data aggregator 312 may be part of a device having another purpose (e.g., validator 308), or may be a separate device or component, such as a server or mobile device. In some embodiments, data aggregator 312 may include various components (e.g., modules, devices, processors, etc.) configured to carry out a data aggregation process (e.g., a process for aggregating and/or analyzing data from sources such as a source API 302 and/or exception handler 310). For example, data aggregator 312 may include a data caching component, a data aggregator component, a data transformation component, a data mapping component, and/or a service router.

Intake sub-system 300 may also include a logging & tracing module 314, which may log and/or trace data associated with communications (e.g., communications from an API source 302). Logging & tracing module 314 may be part of a device having another purpose (e.g., data aggregator 312), or may be a separate device or component, such as a server or mobile device. In some embodiments, logging & tracing module 314 may include various components (e.g., modules, devices, processors, etc.) configured to carry out a data aggregation process (e.g., a process for tracing and/or logging data from sources such as a source API 302 and/or exception handler 310). For example, logging & tracing module 314 may include tracer 316 and/or trace analyzer 318.

Tracer 316 may perform functions to trace data, such as data associated with a communication from an API source 302, validator 308, etc. In some embodiments, tracer 316 may be configured to add trace identifiers and/or span identifiers to data associated with a communication. In some embodiments, tracer 316 may maintain definitions (e.g., user-defined, machine-defined, and/or a combination of user-defined and machine-defined) related to logging and tracing, such as definitions for where to transmit trace and/or log data, a threshold number of traces and/or logs to keep, data formats, particular combinations of identifiers to transmit, and/or particular libraries to trace. In some embodiments, tracer 316 may implement aspects of a function provider, such as Spring Cloud Sleuth.

Trace analyzer 318 may perform functions to analyze data, such as trace data and/or log data, which may be associated with communications from a device (e.g., a device implementing source API 302). For example, trace analyzer 318 may aggregate timing data (e.g., times when an exception occurred, exception frequency, etc.), a tag, rule failure data, rule satisfaction data, a device identifier, a message identifier, and/or any data associated with a source API 302. In some embodiments, trace analyzer 318 may generate visual representations of trace and/or log data (e.g., charts of filterable data, line diagrams, recommendations generated by statistical and/or machine learning algorithms, etc.). In some embodiments, trace analyzer 318 may implement aspects of a function provider, such as Zipkin.

FIG. 3B illustrates an exemplary pictographic representation of an output sub-system 325. Output sub-system 325 may be designated for processing output of the workflow sub-system 375 in FIG. 3D. Output sub-system 325 may pass processed output to external data sources 370 in FIG. 3C, pass processed output to be logged and/or traced with the logging & tracing module 314 in FIG. 3A and/or one or more of the external services 339a-e. Output sub-system 325 may be specifically configured for use by a consumer, a delivery-person, an administrator, and/or a seller. Output sub-system 325 may be implemented on a computing device having a processor, memory component, and/or communications component. In some embodiments, output sub-system 325 and/or components of output sub-system 325 may be communicably coupled to other sub-systems (e.g., as described in FIGS. 3A-3D).

Output sub-system 325 may include a number of Creturns Domains module 327, which may be communicably coupled to workflow sub-system 375 in FIG. 3D. In some embodiments, Creturns Domains module 327 may comprise a variety of services 329a-d. Examples of services as illustrated on FIG. 3B may include CancelService 329a, ReturnService 329b, ExchangeService 329c, and/or ConcessionsService 329d. Each of the services 329a-d may be responsible for processing output from the respective workflow tasks in workflow sub-system 375 in FIG. 3D. For example, cancel process workflow 383a in FIG. 3D may pass an output to CancelService 329a, while return process workflow 383b in FIG. 3D may pass an output to ReturnService 329b. Architecture of Creturns Domains module 327 be modified to add additional services as needed.

Creturns Domains module 327 may pass processed information to external data sources 370 in FIG. 3C, logging and tracing with logging & tracing module 314 in FIG. 3A and/or external service proxy module 331. Information passed to external data sources 370 is stored as described in section with reference to FIG. 3C. Information passed to logging & tracing module 314 is logged and processed as described earlier in section with reference to FIG. 3A.

External service proxy module 331, which is a part of output sub-system 325, may receive processed output from Creturns Domains module 327 for further direction to an appropriate external service 339a-339e. Output sub-system 325 may use external service proxy module 331 to connect repeatedly to the same service without the expenditure of time and computing resources required for initializing a service proxy more than once. External service proxy module 331 may be implemented as a software or a hardware system between Creturns Domains module 327 and external services 339a-339e. External service proxy module 331 may exist on the same machine as output sub-system 325 or on a separate server. External service proxy module 331 may be specifically configured for use by a consumer, an administrator, and/or a seller. External service proxy module 331 may be implemented on a computing device having a processor, memory component, and/or communications component.

External service proxy module 331 may also include an external service worker 333, which may receive data directly from the Creturn WorkflowStarter 381 in FIG. 3D and may be communicably coupled to workflow sub-system 375 in FIG. 3D. External service worker 333 may exist within an external service proxy module 331, or may exist as a separate component, such as a server, to which an external service proxy module 331 may be connected. External service worker 333 may include various components (e.g., modules, devices, processors, etc.) configured to carry out output processing. For example, external service worker 333 may process data that is not processed by the Creturns Domains module 327.

External service proxy module 331 may also include an external API requester 335, to which external service worker 333 may be communicably coupled. External API requester 335 may be part of external service proxy module 331, or may be a separate device or component, such as a server or a virtual instance. In some embodiments, external service proxy module 331 may have a direct communication to external API requester 335 based on which of the external services 339a-e is required to pass the output to, which may have been determined by Creturns Domains module 327 or external service worker 333. For example, if external service required an API for communication, external API requester 335 may request appropriate API information to establish a connection with the required external service. In some embodiments, external API requester 335 may be configured to re-format, split, parse, tag, and/or otherwise re-configure or transmit information from the communication based on at least one rule or algorithm used by the external service.

External service proxy module 331 may also include a Producer 337, to which external service worker 333 may be communicably coupled. Producer 337 may be part of external service proxy module 331, or may be a separate device or component, such as a server or a virtual instance. Producer 337 is used to publish messages to topics. Topics may be divided into a number of partitions, which contain messages. Each message in a partition is assigned and identified by its unique offset. The message itself contains information about what topic and partition to publish to so data can be published to different topics with the same producer. In some embodiments, Producer 337 may be implemented using Kafka.

External service proxy module 331 may pass processed information to logging & tracing module 314 in FIG. 3A and/or external services 339a-e. Information passed to logging & tracing module 314 is logged and processed as described earlier in in section with reference to FIG. 3A. External services 339a-e initiate actions based on the requests. Examples of services as illustrated on FIG. 3B may include OrderService 339a, FulfillmentService 339b, ShipmentService 329c, BenefitService 339d and/or TicketService 339e. Each of the services 329a-d may be responsible for initiation of specific actions. For example, in the event, workflow sub-system 375 in FIG. 3D passes an output for ExchangeService 329c processing, it may initiate a number of external services. Exchange of an item may involve an output to OrderService 339a to order (order instruction may include instruction to buy an item from a supplier, inform a picker to prepare the item, purchase the item online, go to a 3rd party store and pick it up, or other instructions directed to acquiring an item) a new item, output to ShipmentService 339c to generate a return shipping label, and/or an output to FulfillmentService 339b to process returned item. Architecture of output sub-system 325 may be modified to add additional external services as needed.

FIG. 3C illustrates a pictographic representation 355 of an exemplary control sub-system 350, an exemplary returns eventstore 361, an exemplary rule engine 362, and exemplary external data sources 370, consistent with disclosed embodiments.

Control sub-system 350 may be configured to create, update, maintain, and/or manage data used by various components of system 300 in FIG. 3A, 325 in FIG. 3B, and 375 in FIG. 3D. For example, control sub-system 350 may be configured to create, update, and/or modify parameters for managing returns by customers (e.g., rules for approving and rejecting a return by a customer), managing workflows for processing returns, and/or storing specific return events.

As illustrated in FIG. 3C, control sub-system 350 may include a rule management module 351, an event management module 352, and a workflow Management module 353.

Rule management module 351 may be configured to manage rules for processing returns by customers. For example, rule management module 351 may be configured to create and/or modify a rule for declining a return request by a customer. By way of example, rule management module 351 may be configured to create and/or modify a rule for declining a return request by a customer based on various parameters, including, for example, the data relating to the customer's previous return(s), the monetary amount involved in the return request, the type of the goods to be returned, etc. For example, rule management module 351 may create a rule for declining a return request by a customer if the customer returned an empty (or partially empty) box for a return within a predetermined number of days in the past (e.g., 180 days), which may indicate the customer may have attempted to defraud the system.

In some embodiments, rule management module 351 may be configured to create and/or modify a rule based on input by the user of control sub-system 350. For example, rule management module 351 may receive input from the user for modifying one or more parameters of a rule for validating return requests and modifying the parameter(s) of the rule accordingly.

Event management module 352 may be configured to create, modify, and/or manage events stored in returns eventstore 361. For example, event management module 352 may create a series of events for a return request initiated by a customer or the system and store the events into returns eventstore 361. By way of example, a customer may initiate a return of an order via a user device associated with the customer. Event management module 352 may create an event of receiving the return request and store the event in returns eventstore 361. In some embodiments, an event may include information relating to the return, the customer, and the order associated with the return. For example, event management module 352 may create a first event for a return requested by a customer, which may include the information of the return request, the time stamp of receiving the return request, the information relating to the customer, or the like, or a combination thereof. Event management module 352 may create a second event when one or more items subject to the return are received from the customer, which may include the information relating to the item(s) received (e.g., the quantity, condition, etc.), the time stamp of receiving the item(s), etc. Event management module 352 may also store the first and second event as a series of events relating to the return in returns eventstore 361.

In some embodiments, returns eventstore 361 may include, for example, Oracle™ databases, Sybase™ databases, or other relational databases or non-relational databases, such as Hadoop™ sequence files, HBase™, or Cassandra™ Returns eventstore 361 may include NoSQL databases such as HBase, MongoDB™ or Cassandra™. Alternatively, database 320 may include relational databases such as Oracle, MySQL and Microsoft SQL Server. In some embodiments, returns eventstore 361 may take the form of servers, general purpose computers, mainframe computers, or any combination of these components.

Workflow management module 353 may be configured to create, modify, and/or manage workflows used by various components of system 300 in FIG. 3A, 325 in FIG. 3B, and 375 in FIG. 3D. For example, workflow management module 353 may be configured to create, modify, and/or manage cancel process 383a, return process 383b, exchange process 383c, delivery tracking 383d, collect process 383e, refund process 383f, and withdraw process 383g used by workflow sub-system 375 (illustrated in FIG. 3D).

In some embodiments, control sub-system 350 may be configured to create, modify, and/or manage services used by Creturns Domains module 327 (illustrated in FIG. 3B). For example, control sub-system 350 may be configured to create, modify, and/or manage CancelService 329a, ReturnService 329b, ExchangeService 329c, and/or ConcessionsService 329d. Creturns Domains module 327 may obtain one or more services from control sub-system 350.

Rule engine 362 may be configured to obtain rules for processing returns from control sub-system 350, and store and/or manage the rules for other components of the workflow sub-system 375 in FIG. 3D. For example, the workflow sub-system 375 in FIG. 3D may be configured to obtain the rules for validating return requests from rule engine 362. In some embodiments, rule engine 362 may include a rule database 363 for storing the rules for managing and/or processing returns.

External data sources 370 may be configured to store data for various components of system including subsystems 300 in FIG. 3A, 325 in FIG. 3B, and 375 in FIG. 3D. For example, external data sources 370 may store various services created and/or updated by control sub-system 350, including, for example, CancelService 329a, ReturnService 329b, ExchangeService 329c, and/or ConcessionsService 329d. Creturns Domains module 327 may obtain one or more services from external data sources 370.

As another example, external data sources 370 may include an eventstore 371 configured to store data relating to events (e.g., return events). In some embodiments, eventstore 371 may include a write database 372 configured to write data in response to write commands. Eventstore may also include one or more read databases 373 (e.g., read database 373A, read database 373B, etc.) configured to read data only in response to query commands. In some embodiments, a read database 373 may include data that are the same as the data included in write database 372. For example, if the data stored in write database 372 are updated in response to a write command, the corresponding data in read database 373 may be updated accordingly such that write database 373 and read database 373 may include the same data. In some embodiments, external data sources 370 may include an admin database 374 configured to store administration data for control sub-system 350.

In some embodiments, eventstore 371 and/or admin database 374 may include, for example, Oracle™ databases, Sybase™ databases, or other relational databases or non-relational databases, such as Hadoop™ sequence files, HBase™, or Cassandra™ Eventstore 371 and/or admin database 374 may include NoSQL databases such as HBase, MongoDB™ or Cassandra™. Alternatively, database 320 may include relational databases such as Oracle, MySQL and Microsoft SQL Server. In some embodiments, eventstore 371 and/or admin database 374 may take the form of servers, general purpose computers, mainframe computers, or any combination of these components.

FIG. 3D illustrates an exemplary pictographic representation of a workflow sub-system 375. Workflow sub-system 375 may be designated for processing output of the intake sub-system 300. Workflow sub-system 375 may pass Validator 308 output to output sub-system 325. Workflow sub-system 375 may be specifically configured for use by a consumer, a delivery-person, an administrator, and/or a seller. Workflow sub-system 375 may be implemented on a computing device having a processor, memory component, and/or communications component. In some embodiments, workflow sub-system 375 and/or components of workflow sub-system 375 may be communicably coupled to other sub-systems (e.g., as described in FIGS. 3A-3D).

Workflow sub-system 375 may include a framework module 377. Framework module 377 may utilize Spring WebFlux or similar technology. Framework module 377 may provide for a non-blocking web stack to handle concurrency with a small number of threads and scale with fewer hardware resources. Framework module 377 may include a variety of programming modules. Examples of modules as illustrated in FIG. 3D may include return module 379a, exchange module 379b, and cancellation module 379c. Modules 379a-c may contain processing logic for retail, third party, and ticket offers. Modules 379a-c may also include an API for communication with sub-systems responsible for respective data.

Workflow sub-system 375 may also include a WorkflowStarter 381, which may be communicatively coupled to framework module 377. WorkflowStarter 381 may include a list of processes 383a-g, which may initiate workflows based on the input received from the framework module 377. Examples of processes as illustrated in FIG. 3D may include cancel process 383a (containing instructions for starting a workflow initiated by the cancelation of an order by the consumer, supplier, or other order handler), return process 383b (containing instructions for starting a workflow initiated by the complete or partial order return by the consumer, supplier, or other order handler), exchange process 383c (containing instructions for starting a workflow initiated by an exchange of complete or partial order started by the consumer, supplier, or other order handler), delivery tracking 383d (containing instructions for starting a workflow initiated by the request to track delivery status of a complete or partial order by the consumer, supplier, or other order handler), collect process 383e (containing instructions for starting a workflow initiated by the request for tracking information of a complete or partial order by the consumer, supplier, or other order handler), refund process 383f (containing instructions for starting a workflow initiated by a request for refund for a complete or partial order started by the consumer, supplier, or other order handler), and withdraw process 383g (containing instructions for starting a workflow initiated by a withdrawal of complete or partial order started by the consumer, supplier, or other order handler).

Furthermore, each of the programing modules 379a-c of framework module 377 may initiate a plurality of processes 383a-g. For example, cancelation module 379c may initiate delivery tracking process 383d to determine if the item that is being canceled was deliver or is still in possession of the delivery personnel. Same cancelation module 379c may also initiate refund process 383f for issuing a refund to the customer.

Various combinations may be programed and may be specifically configured for use by a consumer, a delivery-person, an administrator, and/or a seller. WorkflowStarter 381 may be implemented on a computing device having a processor, memory component, and/or communications component. In some embodiments, WorkflowStarter 381 and/or components of WorkflowStarter 381 may be communicably coupled to other parts of workflow sub-system 375 (e.g., as described in FIG. 3D). Furthermore, architecture of workflow sub-system 375 be modified to add additional processes and programing modules as needed.

Workflow sub-system 375 may also include a workflow service module 385, which may be communicably coupled to WorkflowStarter 381 and output sub-system 325. Workflow service module 385 may be designated for workflow control and design. Workflow service module 385 may include a Creturn workflow service module 387 and a workflow orchestration module 391. Workflow service module 385 may provide output for processing by output sub-system 325.

Creturn workflow service module 387 may include a number of sub-modules 389a-b which may control workflows based on the input received from the WorkflowStarter 381. Examples of processes as illustrated in FIG. 3D may include retail return sub-module 389a, which allows for design and/or control of the workflows for the return of retail items and third party return sub-module 389b, which allows for design and/or control of the workflows for the return of third party items. Architecture of Creturn workflow service module 387 be modified to add additional sub-modules as needed. Workflows within Creturn workflow service module 387 may be controlled, and/or designed by a consumer, a delivery-person, an administrator, and/or a seller. Creturn workflow service module 387 may be implemented on a computing device having a processor, memory component, and/or communications component and may be communicably coupled to other parts of workflow sub-system 375.

Workflow orchestration module 391 may include a set of workflow controls which may be accessed by a consumer, a delivery-person, an administrator, and/or a seller. Workflow orchestration module 391 may be implemented with a business process management (BPM) engine and supporting frameworks, one example of which may be Activiti with Spring Boot/Docker. A workflow orchestration module 391 engine has as core goal to take a process definition comprised of human tasks and service calls and execute those in a certain order, while exposing various API's to start, manage and query data about process instances for that definition. Workflow orchestration module 391 may be implemented on a computing device having a processor, memory component, and/or communications component. Workflow orchestration module 391 may be communicably coupled to other parts of workflow sub-system 375.

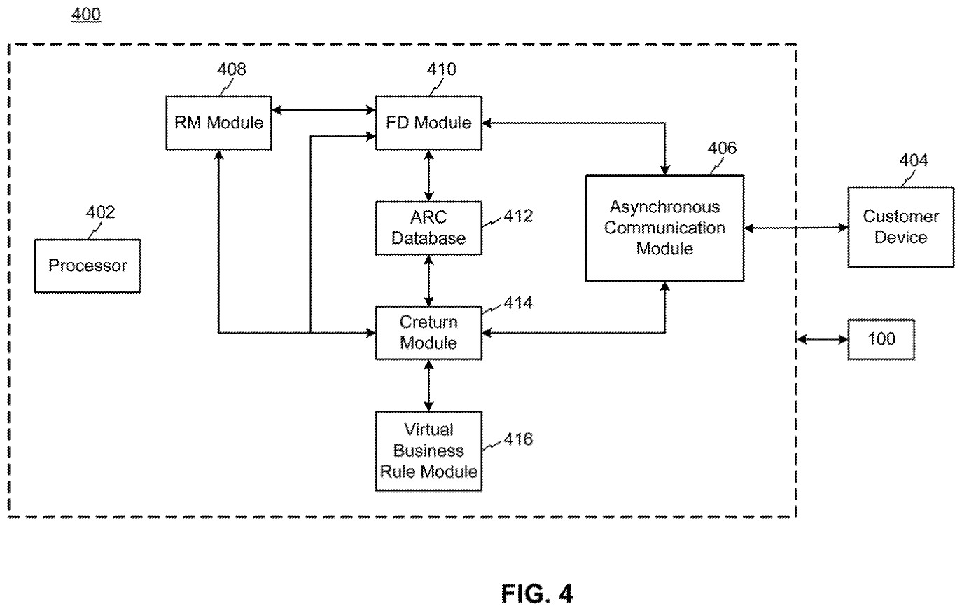

FIG. 4 is a block diagram illustrating an exemplary system 400 for fraud detection and customer abuse consistent with the disclosed embodiments. System 400 may generate a profile of a customer requesting a refund to determine if the customer may be making fraudulent refund request that are either blocked or approved. System 400 may include one or more processors 402 (referred to herein as processor 402), a customer device 404, an asynchronous communication module 416 (referred to herein as asynchronous communication 406), a Return Management (RM) module 408 (referred to herein as RM 408), a Fraud Detection (FD) module 410 (referred to herein as FD 410), an Abuser Refund Control database (ARC) 412 (referred to herein as ARC 412), a Creturn module 414 (referred to herein as Creturn 414), and a Virtual Business Rule module 416 (referred to herein as virtual business rule 416). The customer device 404 may communicate with System 400 to request a refund relating to an order. The customer device 404 may communicate with system 400 with asynchronous communication 406, which may allow for system 400 to continue processing the customer device 404's refund request in case that communication may be lost between the customer device 404 and system 400. The RM 408 may check that there may be a return package and its content associated with the customer device 404's refund request. The FD 410 may determine whether to block or approve the refund associated with the customer device 404 based on rules (described below) that may determine that the customer may be making fraudulent refund requests or abusing refund requests. The ARC 412 continuously stores information or data associated with the customer using the customer device 404 regarding refund requests, whether the FD 410 has blocked or approved current and past refund requests of the customer regardless of devices used by the customer. The ARC 412 may store and generate a profile regarding refund requests associated with the customer using the customer device 404. The Creturn 414 may make the final determination that the customer using the customer device 404's refund request is approved or blocked based on business rules using virtual business rule 416 (described below). System 400 may acquire additional information regarding the refund request associated with the customer device 404 in system 100.

System 400 may determine whether a refund request received from the customer device 404 associated with a return package for a product such as a retail good or a fresh food product may be fraudulent based on a current order id or previous orders and/or refund requests associated with the customer using customer device 404. In some embodiments, a retail good may be any product that may not be consumed or ingested by the customer, while fresh food products may be consumed or ingested by the customer.

In some embodiments, a current order id or previous orders may be identified as fraudulent if the return package associated with the customer device 404's refund request may be assigned an empty designation—a package may be received, but the package may not have the item(s) associated with the current order id—, assigned a partial designation—a package may be received, but the package may only contain some of the item(s) associated with the current order id—, or assigned a not returned designation—a package may not have been received at all. The current order id or previous orders may be identified as not fraudulent if the return package associated with the customer device 404's refund request may be complete designation—a package may be received with all of its items. The customer using customer device 404's previous orders and/or refund requests may be based on a profile of the customer, from which system 400 may identify that the customer using customer device 404 may be associated with fraudulent refund requests due to fraudulent or abusive refund requests. Once system 400 may identify the customer as associated with fraudulent refund requests or abusing refund requests, the customer using customer device 404 may be assigned as a fraudulent member and the refund request associated with the order id or future refund requests may be assigned as block refund—preventing the customer using customer device 404 from receiving a refund.

System 400 may utilize the functions of system 100, sub-system 300, sub-system 325, sub-system 355, and sub-system 375 through processors 402. Processor 402 may access, control, and execute all the processors and functionalities in system 100, sub-system 300, sub-system 325, sub-system 355, and sub-system 375. Processor 402 may be configured to identify whether a refund request may be fraudulent and/or the customer using the customer device 404 may abuse refund requests. Processor 402 may receive a refund request from the customer device 404 associated with an order id. The customer device 404 may be a mobile device, a tablet/personal digital assistant (PDA), a computer, or the like that may access the external front end system 103 or its applications. Processor 402 may be communicably coupled with the customer device 404 with intake sub-system 300 where, for example, the customer device 404 may be API 302 and system 400 may be API 304. Furthermore, in the event that there may be a loss of communication with the customer device 404, processor 402 may also be communicably coupled to the customer device 404 with asynchronous communication 406. Processor 402 may utilize asynchronous communication 406 to access the functions of output sub-system 325 where, for example, external service proxy module 331 may be executed by Processor 402 for asynchronous communication between the customer device 404's device and system 400. Furthermore, processor 402 in system 400 may be communicably coupled with the system 100 through intake sub-system 300 where, for example, the system 100 and the system 400 may be, respectively, API 302 and API 304, or vice versa. In the event that the system 400 and the system 100 may lose communication, processor 402 may execute the functions of output sub-system 325 where, for example, external service proxy module 331 may be executed by processor 402 for asynchronous communication between the system 400 and the system 100.

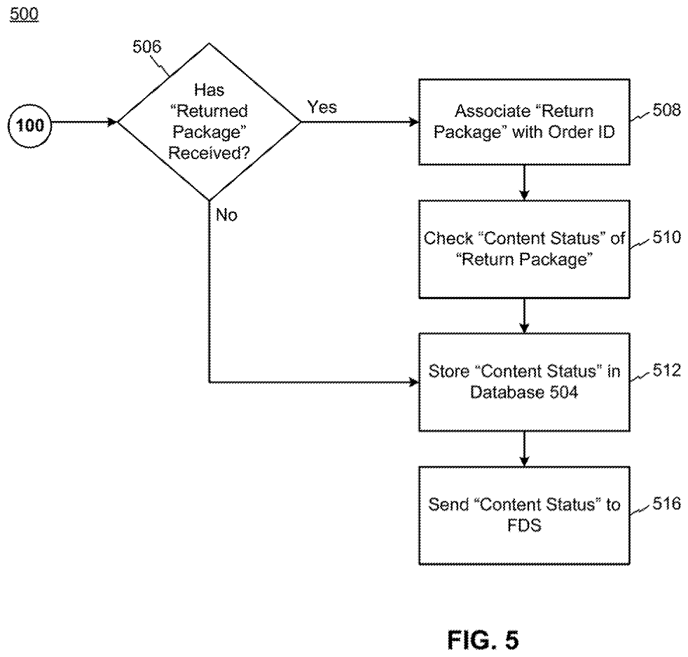

When processor 402 may receive the refund request associated with the order id from the customer device 404, processor 402 may receive a content status from the RM 408 (described below with respect to FIG. 5) associated with a return package from the customer. The return package from the customer using customer device 404 may be associated with the refund request of the customer device 404. Processor 402 may determine whether the return package's content status may be empty designation, partial designation, or not returned designation. In one embodiment, processor 402 may execute event management module 352 to determine the content status of the return package associated with the customer device 404 from system 100 to store in returns eventstore 361. Processor 402 may search the content status of the return package associated with the customer device 404 in returns eventstore 361 and store the content status of the return package in the RM 408. Processor 402 may send the content status to the FD 410. The RM 408 may be communicably coupled with the FD 410 through intake sub-system 300 where, for example, the FD 410 and the RM 408 may be, respectively, API 302 and API 304, or vice versa. In the event that the RM 408 and the FD 410 may lose communication, processor 402 may execute the functions of output sub-system 325 where, for example, external service proxy module 331 may be executed by processor 402 for asynchronous communication between the FD 410 and the RM 408.

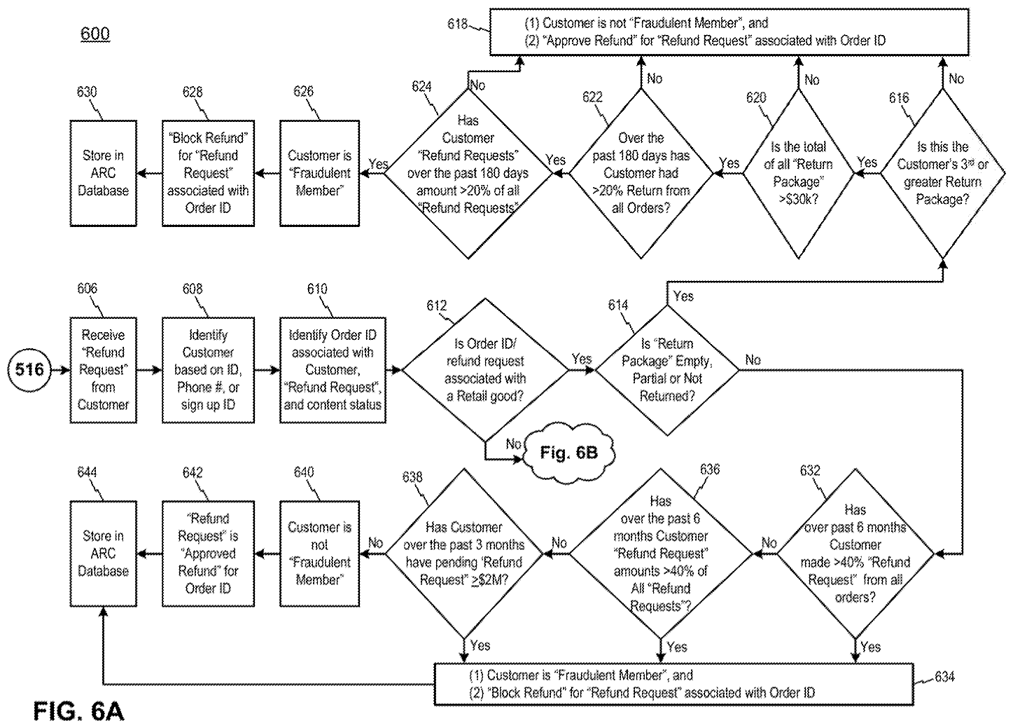

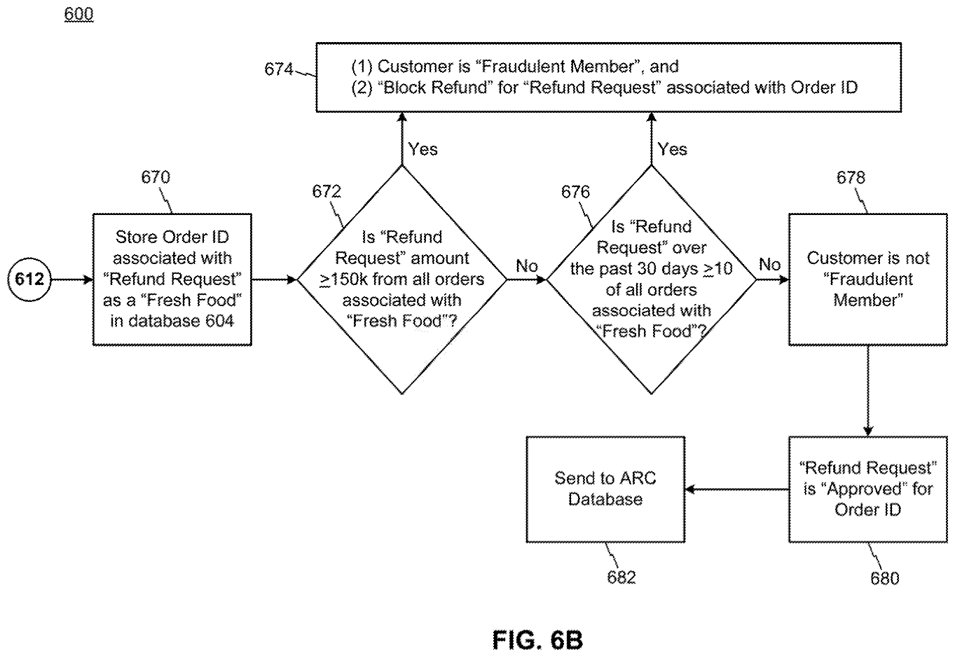

The FD 410 may receive the content status (described below with respect to FIGS. 6A & 6B) associated with the return package of the customer using customer device 404 from the RM 408 and, also, may receive the refund request from the customer device 404. In FD 410, processor 402 may associate the content status of the return package and the order id of the refund request. Based on the customer device 404, the order id of the refund request, and the content status of the return package processor 402 in FD 410 may execute rule definitions (described below with respect to FIGS. 6A & 6B) to determine whether the customer device 404's refund request may be rejected/blocked where FD 410 may assign the label to the refund request as “block refund,” or “granted”/“approved” where FD 410 may assign the label to the refund request as “approve refund.” The customer device 404 may receive a notification from system 400 that the refund request is blocked or approved. In one embodiment, processor 402 may execute rule engine 362, the rule database 363, and the control sub-system 350 for determining the rule definitions to the block refund or the approve refund for the refund request. If processor 402 in FD 410 determines that the refund request is assigned the label as the block refund, then processor 402 also determines that the customer using customer device 404 is assigned the label a fraudulent member (described below with respect to FIGS. 6A & 6B)—the customer using customer device 404 may be prevented from receiving any approve refund assigned labels for current and future refund requests. In another embodiment, if processor 402 in FD 410 determines that the refund request is assigned the label as the approve refund, then processor 402 also determines that the customer is assigned the label of a not fraudulent member—the customer using customer device 404 may receive approve refund labels for current and future refund requests. The block refund assigned label or the approve refund assigned label of a refund request may be a refund status. The assigned label of the fraudulent member or the not fraudulent member for the customer using customer device 404 may be a member fraud status. Even if the customer using customer device 404 may have received a previous refund status and a previous member fraud status and may attempt to disguise a new refund request by using another device or a different name, processor 402 in FD 410 may execute logging & tracing module 314 to recognize the customer associated with the previous refund status and the previous member fraud status. Processor 402 may store the refund status and the member fraud status associated with the customer using customer device 404 and the refund request to the ARC 412 (described below with respect to FIGS. 6A & 6B). The FD 410 may be communicably coupled with the ARC 412 through intake sub-system 300 where, for example, the ARC 412 and the FD 410 may be, respectively, API 302 and API 304, or vice versa. In the event that the FD 410 and the ARC 412 may lose communication, processor 402 may execute the functions of output sub-system 325 where, for example, external service proxy module 331 may be executed by Processor 402 for asynchronous communication between the ARC 412 and the FD 410.

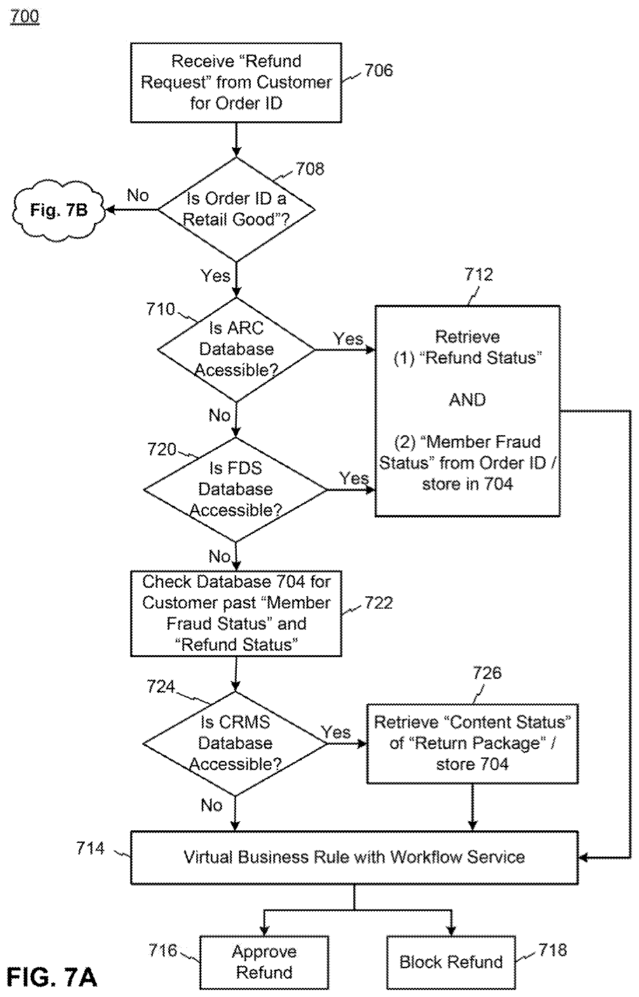

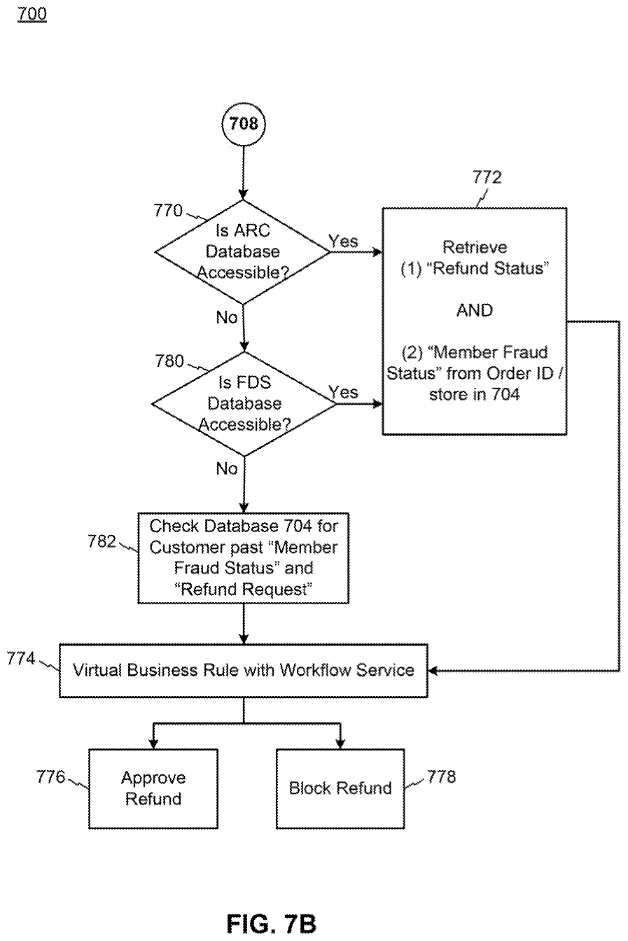

Processor 402 may continuously and automatically build a profile of the customer using customer device 404 from the refund status and the member fraud status of the current order id associated with the device or from refund status and member fraud status from previous orders associated with previous devices in ARC 412. In one embodiment, the ARC 412 may be the external data sources 370. Processor 402 may continuously update or aggregate the profile of the customer using customer device 404 in ARC 412 based on the customer's current and previous orders, current and previous devices, current and previous refund requests, current and previous fraud status, and/or current and previous member fraud status. Processor 402 may send the fraud status and the member fraud status to the Creturn 414 (described below with respect to FIGS. 7A & 7B) for a final determination of the refund request fraud status and member status. The Creturn 414 may be communicably coupled with the ARC 412 through intake sub-system 300 where, for example, the ARC 412 and the Creturn 414 may be, respectively, API 302 and API 304, or vice versa. In the event that the Creturn 414 and the ARC 412 may lose communication, processor 402 may execute the functions of output sub-system 325 where, for example, external service proxy module 331 may be executed by Processor 402 for asynchronous communication between the ARC 412 and the Creturn 414.

The Creturn 414 may receive and/or request the fraud status and the member status from the ARC 412. Processor 402 in the Creturn 414 may override the FD 410 fraud status and member status determinations to block refund or approve refund for the refund request from the customer device 404 associated with the order id. In another embodiment, the Creturn 414 may execute the FD 410 fraud status and member status determinations to block refund or approve refund for the refund request from the customer device 404 associated with the order id.

Processor 402 may be communicably coupled with customer device 404 with intake sub-system 300 where, for example, the customer device 404 may be API 302 and Creturn 414 may be API 304. Furthermore, in the event that the Creturn 414 and the customer device 404 may lose communication, processor 402 may execute the functions of output sub-system 325 where, for example, external service proxy module 331 may be executed by Processor 402 for asynchronous communication between the ARC 412 and the Creturn 414 via the asynchronous communication 406. Moreover, in the event that there may be no data associated with the refund request of the customer device 404 in the ARC 412, processor 402 may be communicably coupled with the FD 410 through intake sub-system 300 where, for example, the FD 410 and the Creturn 414 may be, respectively, API 302 and API 304, or vice versa. In the event that the Creturn 414 and the FD 410 may lose communication, processor 402 may execute the functions of output sub-system 325 where, for example, external service proxy module 331 may be executed by Processor 402 for asynchronous communication between the FD 410 and the Creturn 414. Furthermore, in the event that there may be no data associated with the refund request of the customer device 404 in the FD 410, processor 402 may be communicably coupled with the RM 408 through intake sub-system 300 where, for example, the RM 408 and the Creturn 414 may be, respectively, API 302 and API 304, or vice versa. In the event that the Creturn 414 and the RM 408 may lose communication, processor 402 may execute the functions of output sub-system 325 where, for example, external service proxy module 331 may be executed by Processor 402 for asynchronous communication between the CRMS 410 and the Creturn 414.

Processor 402 in Creturn 414 may execute the functions of control sub-system 350 to modify or override the rule definitions in the FD 410 to determine if the customer device 404 refund request may be block refund or approve refund. In yet another embodiment, processor 402 in Creturn 414 may execute the virtual business rule 416 to modify or override the rule definitions in the FD 410 through the workflow sub-system 375. Virtual business rule 416 may allow an administrator or a business user to create new rules based on new business needs that would assign a label to the customer as a fraudulent member despite the ARC 412 having the customer using customer device 404 as the not fraudulent member. In another embodiment, virtual business rule 416 may allow the administrator or the business user to create new rules based on new business needs that would assign the label to the customer using customer device 404 as a not fraudulent member despite the ARC 412 having the customer as the fraudulent member. In yet another embodiment, virtual business rule 416 may allow an administrator or a business user to create new rules based on new business needs that would assign the label to the refund request as a block refund despite the ARC 412 having the refund request as the approve refund. In yet another embodiment, virtual business rule 416 (described below with respect to FIGS. 7A & 7B) may allow the administrator or the business user to create new rules based on new business needs that would assign the label to the refund request as an approve refund despite the ARC 412 having the refund request as the block refund. The administrator or the business user may interact with the workflow service module 385 to create the new rules based on new business needs without the need for an experienced programmer to hardcode rule definitions in the FD 410. The administrator or the business user may be a laypersons in programing where the administrator or the business person may virtually create refund sub-modules, similar to retail return sub-module 389a or third party return sub-module 389b, to create new rules according to business needs. Processor 402 may then execute virtual business rules 416 to modify or override the refund status or the member fraud status to block refund or approve refund associated with the customer device 404's refund request based on the new rules.

The virtual business rule 416 may be communicably coupled with the Creturn 414 through intake sub-system 300 where, for example, the virtual business rule 416 and the Creturn 414 may be, respectively, API 302 and API 304, or vice versa. In the event that the Creturn 414 and the virtual business rule 416 may lose communication, processor 402 may execute the functions of output sub-system 325 where, for example, external service proxy module 331 may be executed by Processor 402 for asynchronous communication between the Creturn 414 and the virtual business rule 416.

In another embodiment, processor 402 may execute and have access to all of the functions of system 100 and sub-system 300, 325, 355, and 375 for executing for each the asynchronous communication 406, the RM 408, the FD 410, the ARC 412, the Creturn 414, and/or the virtual business rule 416 simultaneously.

FIG. 5 is a flow chart of an exemplary method 500 of determining a content status for a return package, consistent with the disclosed embodiments. The steps of method 500 depicts an embodiment detailing the steps in the RM 408. The steps of method 500 may be performed by processor 402 executing intake sub-system 300 where the determination of a content status and an order id associated with a return package in system 100 may be executed by validator 308, exception handler 310, data aggregator 312, and logging & tracing module 314. At step 506, processor 402 may determine from system 100 if the return package was received. At step 506, if processor 402 determines that the return package was received (step 506—yes), then processor 402 further determines at step 508 the order id associated with the return package. Processor 402 may store the order id associated with the return package in database 504.

At step 510, processor 402 may check the content status of the return package from system 100 where processor 402 may determine whether the return package may be empty designation, partial designation, not returned designation, or complete designation.

At step 512, processor 402 may store the content status of the return package in database 504. However, If processor 402 determines that the return package was not received (step 506—no), then processor 402 store the content status of the return package as not returned designation in database 504. Database 504 may aggregate all content status associated with all return package for all current and previous order ids.

At step 516, processor 402 may send the content status and the order id associated with the return package stored in database 504 to the FD 410.

FIGS. 6A and 6B are flow charts of an exemplary method 600 of determining a refund status and a member status based on rule definitions for retail goods or fresh food products, consistent with the disclosed embodiments. The steps of method 600 depicts an embodiment detailing the steps in the FD 410. The steps of method 600 may be performed by processor 402 executing intake sub-system 300 where the determination of an identity of the customer, the order id, whether the return package may be a retail good or a fresh food product, the content status associated with a refund request in system 100, asynchronous communication 406, and the RM 408 may be executed by validator 308, exception handler 310, data aggregator 312, and logging & tracing module 314. The steps of method 600 may be performed by processor 402 executing rule engine 362, the rule database 363, and the control sub-system 350 for determining the rule definitions for the refund status and member fraud status associated with the refund request. Processor 402 may store the identity of the customer, the order id, the customer device 404, whether the return package may be the retail good or the fresh food product, the content status, the refund status, the member fraud status associated with the refund request in database 604. Processor 402 may aggregate or accumulate a profile—information—in database 604 of the customer using customer device 404 from the current order id, the customer device 404, the refund request, previous orders associated with previous refund requests, previous devices, previous content statuses and return packages from database 504, previous refund statuses, and previous member fraud statuses.

After performing step 516 in FIG. 5, at step 606, processor 402 may receive the refund request from the customer device 404's device. At step 608, processor 402 may determine the identity of the customer using customer device 404 with logging & tracing module 314, which may be stored in database 604. Even if the customer using customer device 404 may attempt to hide its identity by using different devices, sign up ids, name, physical addresses, IP addresses, MAC addresses, or communication formats, processor 402 may determine the identity of the customer using customer device 404 based on current and previous aggregated or accumulated information—the profile—by processor 402 in database 604.

At step 610, processor 402 may identify the order id associated with the customer device 404 and the refund request—from system 100—, and the content status—from database 504 in RM 408. Processor 402 may store the order id in database 604.

At step 612, processor 402 may determine from the order id whether the refund request may be associated with the retail good or a fresh food product—information determined in system 100. If processor 402 determines that the refund request may be associated with a fresh food product (step 612—no), then processor 402 proceeds to FIG. 6B. However, if processor 402 determines that the refund request may be associated with the retail good (step 612—yes), then, at step 614, processor 402 determines the content status of the return package from database 504 in RM 408. If processor 402 determines that the content status of the return package may be associated with the refund request may be empty designation, partial designation, or not returned designation (step 614—yes), then, at step 616, processor 402 determines whether the customer's return package is at least a third return package from all return package from the customer. If processor 402 determines that the return package may not be the at least third return package (step 616—no), then, at step 618, processor 402 determines that the customer's assigned label may not be “fraudulent member,” and processor 402 may determine that the refund request assigned label may be approve refund. Processor 402 may store the assigned labels not fraudulent member and approve refund—member fraud status and refund status, respectively—in database 604.

However, if processor 402 determines that the return package may be the at least third return package (step 616—yes), then, at step 620, processor 402 determines that a total value of all return package from the customer may be greater than a first threshold price, $30,000 as an example. If processor 402 determines that the total value of all return package from the customer using customer device 404 may be less than or equal to the first threshold price, $30,000 as an example, then processor 402 executes the step 618.

However, if processor 402 determines that the total value of all return package from the customer using customer device 404 may be greater than the first threshold price (step 620—yes), then, at step 622, processor 402 determines whether, over a past first threshold time, 180 days as an example, the customer using customer device 404 had a number of return package greater than a first threshold percentage, 20% as an example, of all orders requested by the customer. If processor 402 determines that, over the past first threshold time, 180 days as an example, the customer using customer device 404 may have had the number of return package less than or equal to the first threshold percentage, 20% as an example, of all orders requested by the customer using customer device 404 (step 622—no), then processor 402 executes the step 618.

However, if processor 402 determines that, over the past first threshold time, the customer using customer device 404 may have had the number of return package greater than the first threshold percentage of all orders requested by the customer using customer device 404 (step 622—yes), then, at step 624, processor 402 determines whether, over the past first threshold time, the customer's refund requests may have amounted to more than the first threshold percentage of all refund requests by the customer. If processor 402 determines that, over the past first threshold time, the customer's refund request may have amounted to less than or equal to the first threshold percentage of all refund requests by the customer (step 624—no), then processor 402 executes the step 618.

However, if processor 402 determines that, over the past first threshold time, the customer device 404's refund request may have amounted to more than the first threshold percentage of all refund requests by the customer using customer device 404 (step 624—yes), then, at step 626, processor 402 assigns the label to the customer using customer device 404 as fraudulent member and stores the assigned label in database 604. At step 628, processor 402 may assign the label to the refund request associated with the order id as block refund and may store the assigned label in database 604. At step 630, processor 402 may store the member fraud status and the refund status in ARC 412. In addition, processor 402 may store in ARC 412 all the information in database 604.

However, if processor 402 determines that the content status of the return package associated with the refund request may be complete designation (step 614—no), then, at step 632, processor 402 determines whether, over a past second threshold time, 6 months as an example, the customer using customer device 404 may have had a number of refund requests greater than a second threshold percentage, 40% as an example, of all orders by the customer. If processor 402 determines that, over the past second threshold time, 6 months as an example, the customer using customer device 404 may have had the number of refund requests greater than the second threshold percentage, 40% as an example, of all orders by the customer (step 632—yes), then, at step 634, processor 402 determines that the customer's assigned label may be fraudulent member, and processor 402 may determine that the refund request assigned label may be block refund. Processor 402 may store the assigned labels fraudulent member and block refund—member fraud status and refund status, respectively—in database 604.

However, if processor 402 determines that, over the past second threshold time, the customer may have had the number of refund request less than or equal to the second threshold percentage of all orders by the customer (step 632—no), then, at step 636, processor 402 determines whether, over the past second threshold time, the customer refund requests may have amounted to more than the second threshold percentage of all refund requests by the customer. If processor 402 determines that, over the past second threshold time, the customer refund requests may have amounted to more than the second threshold percentage of all refund requests by the customer (step 636—yes), then, processor 402 executes the step 634.

However, if processor 402 determines that, over the past second threshold time, the customer refund requests may have amounted to less than or equal to the second threshold percentage of all refund requests by the customer (step 636—no), then, at step 638, processor 402 determines whether, over a past third threshold time, 3 months as an example, the customer may have pending refund requests amounting to a second threshold price or more, $2,000,000 or more as an example. If processor 402 determines that, over the past third threshold time, 3 months as an example, the customer using customer device 404 may have pending refund requests amounting to the second threshold price or more, $2,000,000 or more as an example (step 638—yes), then, processor 402 executes the step 634.

However, if processor 402 determines that, over the past third threshold time, the customer using customer device 404 may have pending refund request amounting to less than the second threshold price (step 638—no), then, at step 640, processor 402 assigns the label to the customer as not fraudulent member and stores the assigned label in database 604. At step 642, processor 402 may assign the label to the refund request associated with the order id as approve refund and may store the assigned label in database 604. At step 644, processor 402 may store the member fraud status and the refund status in ARC 412. In addition, processor 402 may store in ARC 412 all the information in database 604.

Referring to FIG. 6B after performing step 612 in FIG. 6A, processor 402 may determine that there may be no return package because system 400 may restrict return package associated with fresh food products. The customer device 404 may only request refund requests for fresh food products. At step 670, processor 402 may store in database 604 that the order id associated with the refund request may be the fresh food product.

At step 672, processor 402 may determine whether the refund request of the customer device 404 may amount to more than or equal to a third threshold price, $150,000 as an example, from all orders associated with the fresh food product by the customer. Database 604 may have the current and aggregated/accumulated previous orders associated with the fresh food product for the customer. If processor 402 determines that the refund request of the customer device 404 may amount to more than or equal to the third threshold price, $150,000 as an example, from all orders associated with the fresh food product by the customer (step 672—yes), then, at step 674, processor 402 determines that the customer's assigned label may be fraudulent member, and processor 402 may determine that the refund request assigned label may be block refund. Processor 402 may store the assigned labels fraudulent member and block refund—member fraud status and refund status, respectively—in database 604.

However, if processor 402 determines that the refund request of the customer device 404 amounts to less than the third threshold price from all orders associated with the fresh food product by the customer (step 672—no), then, at step 676, processor 402 determines whether, over a past fourth threshold time, 30 days as an example, a number of refund requests associated with the fresh food product may be more than or equal to a first threshold number, 10 as an example, of all orders associated with fresh food product by the customer. If processor 402 determines that, over the past fourth threshold time, the number of requests associated with the fresh food product may be more than or equal to the first threshold number of all orders associated with fresh food product by the customer (step 676—yes), then processor 402 executes the step 674.

However, if processor 402 determines that, over the past fourth threshold time, the number of requests associated with the fresh food product may be less than first threshold number of all orders associated with the fresh food product by the customer (step 676—no), then, at step 678, processor 402 assigns the label to the customer as fraudulent member and stores the assigned label in database 604. At step 680, processor 402 may assign the label to the refund request associated with the order id as block refund and may store the assigned label in database 604. At step 682, processor 402 may store the member fraud status and the refund status in ARC 412. In addition, processor 402 may store in ARC 412 all the information in database 604.

FIGS. 7A and 7B is a flow chart of an exemplary method 700 of determining a final refund status or a final member status based on business rules for retail goods or fresh food products, consistent with the disclosed embodiments. The steps of method 700 depicts an embodiment detailing the steps in the Creturn 414 and the virtual business rule 416. The steps of method 700 may be performed by processor 402 executing intake sub-system 300 to communicate with system 100, the customer device 404, asynchronous communication 406, the RM 408 and database 504, the FD 410 and database 604, the ARC 412 via API 302 where validator 308, exception handler 310, data aggregator 312, and logging & tracing module 314 may process data received from API 302. In one embodiment, the steps of method 700 may be performed by processor 402 executing the rule management module 351, the workflow management module 353, the framework module 377, the WorkflowStarter 381, the workflow service module 385, the ConcessionsService 329d in Creturns Domains module 327, the external service proxy module 331, and the BenefitService 339d in external service 339a-339e.

Processor 402 may execute the steps of method 700 to receive the refund status and the member fraud status determination of the FD 410 and may either approve refund or block refund according to the determination of the FD 410. In another embodiment, processor 402 may execute the steps of method 700 to receive the refund status and the member fraud status determination of the FD 410 and may override the refund status and the member fraud status determination of the FD 410 to approve refund for the fraudulent member with the refund request assigned as block refund. In yet another embodiment, processor 402 may execute the steps of method 700 to receive the refund status and the member fraud status determination of the FD 410 and may override the refund status and the member fraud status determination of the FD 410 to block refund for the not fraudulent member with the refund request assigned as approve refund. In yet another embodiment, processor 402 may execute the steps of method 700 to receive the refund status and the member fraud status determination of the FD 410 and may override the member fraud status determination of the FD 410 by changing the fraudulent member to not fraudulent member to approve refund for an otherwise block refund. In yet another embodiment, processor 402 may execute the steps of method 700 to receive the refund status and the member fraud status determination of the FD 410 and may override the member fraud status determination of the FD 410 by changing the not fraudulent member to fraudulent member to block refund for an otherwise approve refund. Processor 402 in the steps of method 700 may override the FD 410's refund status and member status based on business rules, which processor 402 receives from the virtual business rule 416 in workflow service module 385.

Business rules may be determined by the administrator or the business user when, for example, a product in a market place associated with the customer device 404's refund request may not be generating high revenues in system 100, and the administrator or the business user may desire to increase sales by promoting the purchase of the product in system 100 by changing all refund status to approve regardless of the customer's member fraud status. Furthermore, business rules may be determined by the administrator or the business user when, for example, the product in system 100 associated with the customer device 404's refund request may be deemed as defective by its manufacturer, and the administrator or the business user may, accordingly, change all refund status to approve regardless of the customer's member fraud status. Moreover, business rules may be changed by the administrator or the business user to promote the product in system 100, which generates more purchases by the customer or to deter fraudulent activities related to the product in system 100 by the customer. Furthermore, business rules may be changed by the administrator or the business user to attract the customer to purchase more products in system 100 or deter the customer from purchasing more products in system 100.

If processor 402, in executing the steps of method 700 for Creturn 414, receives the refund request of the customer device 404, but the processor 402 may not communicate with the ARC 412, the FD 410, and the RM 408, then processor 402 directly requests from database 504 the content status associated with the customer device 404 for the retail good and directly requests from database 604 the identity of the customer and the order id. Furthermore, processor 402 may with the content status, the identity of the customer, and the order id determine the refund status and the member status by executing the rule management module 351, the framework module 377, and the refund process 383f in WorkflowStarter 381 to either block refund or approve refund by notifying the customer device 404 of the refund status to the ConcessionsService 329d in Creturns Domains module 327, the external service proxy module 331, and the BenefitService 339d in external service 339a-339e. In yet another embodiment, processor 402 may, after executing the rule management module 351, the framework module 377, and the refund process 383f in WorkflowStarter 381, proceed with the business rule received from the workflow service module 385 (virtual business rule 416) to determine the refund status and the member fraud status. Next, processor 402 in the steps of method 700 may notify the customer device 404 by sending the refund status to the ConcessionsService 329d in Creturns Domains module 327, the external service proxy module 331, and the BenefitService 339d in external service 339a-339e. In yet another embodiment, processor 402 in executing the steps of method 700 may entirely bypass the RM 408, the FD 410, and the ARC 412 to make the determination of the refund status and the member fraud status based on the business rules received from the virtual business rule 416 to notify the customer device 404 of the refund status through the ConcessionsService 329d in Creturns Domains module 327, the external service proxy module 331, and the BenefitService 339d in external service 339a-339e.

At step 706, processor 402 may receive the refund request from the customer device 404. Processor 402 may identify the order id associated with the customer and the refund request—from system 100.

At step 708, processor 402 may determine whether the order id or the refund request may be associated with the retail good or the fresh food product—information determined in system 100. In yet another embodiment, processor 402 in step 708 may receive the determination of whether the order id or the refund request may be associated with the retail good or the fresh food product from FD 410 and/or its database 604. If processor 402 determines that the refund request may be associated with the fresh food product (step 708—no), then processor 402 proceeds to FIG. 7B.

However, if processor 402 determines that the refund request may be associated with the retail good (step 708—yes), then, at step 710, processor 402 determines whether the ARC 412 may be accessible. If processor 402 determines that the ARC 412 may be accessible (step 710—yes), then, step 712, processor 402 retrieves the refund status and the member fraud status associated with the refund request from the ARC 412 and store the refund status and the member fraud status in database 704. Processor 402 may store refund statuses and member fraud statuses from previous orders of the customer in the database 704. Processor 402 may store all the information in ARC 412 in database 704.

At step 714, processor 402 may use the refund status and the member fraud status from the FD 410 or may override the refund status and/or the member fraud status with the business rules in the virtual business rule 416. At step 716, processor 402 may approve refund for the refund request of the customer where a notification may be sent to the customer device 404, or at step 718, processor 402 may block refund for the refund request of the customer using customer device 404 where the notification may be sent to the customer device 404.

However, if processor 402 determines that the ARC 412 may not be accessible (step 710—no), then, at step 720, processor 402 determines whether the database 604 may be accessible. If processor 402 determines that the database 604 may be accessible (step 720—yes), then, processor 402 executes the steps 712 and 716 or 718.

However, if processor 402 determines that the database 604 may not be accessible (step 720—no), then, at step 722, processor 402 searches the database 704 for previous refund statuses and member fraud statuses from previous orders associated with the customer.

At step 724, processor 402 may determine whether the database 504 may be accessible. If processor 402 determines that the database 504 may be accessible (step 724—yes), then, at step 726, processor 402 retrieves the content status of the return package associated with the refund request of the customer device 404 and stores the content status to database 704. At step 714, processor 402 may determine the refund status and the member fraud status of the refund request by executing existing rule definitions in the FD 410 and/or using the business rules in the virtual business rule 416. Processor 402 may, then, proceed with step 716 or step 718.

However, If processor 402 determines that the database 504 may not be accessible (step 724—no), then, at step 714, processor 402 determines the refund status and the member fraud status associated with the refund request based on the customer's previous refund statuses and member fraud statuses. Processor 402 may execute existing rule definitions in the FD 410 and/or the business rules in the virtual business rule 416 to determine the refund status and the member fraud status associated with the refund request of the customer device 404. Processor 402 may, then, proceed with step 716 or step 718.

Referring to FIG. 7B after performing step 708, processor 402 may determine at step 770 whether the ARC 412 may be accessible. If processor 402 determines that the ARC 412 may be accessible (step 770—yes), then, step 772, processor 402 retrieves the refund status and the member fraud status associated with the refund request from the ARC 412 and stores the refund status and the member fraud status in database 704.

At step 774, processor 402 may use the refund status and the member fraud status from the FD 410 or may override the refund status and/or the member fraud status based on the business rules in the virtual business rule 416. At step 776, processor 402 may approve refund for the refund request of the customer using customer device 404 where a notification may be sent to the customer device 404, or at step 778, processor 402 may block refund for the refund request of the customer using customer device 404 where the notification may be sent to the customer device 404.

However, if processor 402 determines that the ARC 412 may not be accessible (step 770—no), then, at step 780, processor 402 determines whether the database 604 may be accessible. If processor 402 determines that the database 604 may be accessible (step 780—yes), then, processor 402 executes the steps 772 and 776 or 778.

However, if processor 402 determines that the database 604 may not be accessible (step 780—no), then, at step 782, processor 402 searches the database 704 for previous refund statuses and member fraud statuses from previous orders associated with the customer.

At step 774, processor 402 determines the refund status and the member fraud status associated with the refund request based on the customer's previous refund statuses and member fraud statuses. Processor 402 may execute existing rule definitions in the FD 410 and/or the business rules in the virtual business rule 416 to determine the refund status and the member fraud status associated with the refund request of the customer device 404. Processor 402 may, then, proceed with step 776 or step 778.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for return fraud detection and prevention, the system comprising:
a memory storing instructions; and
at least one processor configured to execute the instructions to perform steps comprising:
receiving a refund request from a customer associated with an order id and a device;
identifying a content status associated with a return package associated with the order id and the device;
associating the refund request with the order id, the device, and the content status associated with the return package;
determining the customer associated with the refund request based on the device and the content status;
aggregating a profile of the customer based on the refund request, the device, and the content status;
assigning a refund status and a fraudulent member status associated with the refund request of the customer based on at least one rule definition and the profile of the customer;
determining an approval or rejection of the refund request based on the refund status, the fraudulent member status, and at least one business rule;
providing the device of the customer with the approval or rejection of the request refund;
when approval of the refund request is determined, directing a refund to be issued to the customer; and
when rejection of the refund request is determined, preventing the refund from being issued to the customer;
wherein determining the customer associated with the refund request is further based on the aggregated profile via analysis of trace identifiers or span identifiers added to data associated with communications used to generate the aggregated profile, such that the customer is determined even when previous customer activity is associated with a different device, user id, name, physical address, IP address, MAC address, or communication format.

2. The system of claim 1, wherein the device includes a mobile phone, a computer, or a personal digital assistant.

3. The system of claim 1, wherein the device connects to a user interface.

4. The system of claim 1, wherein the return package includes one or more items.

5. The system of claim 1, wherein the content status includes empty designation, partial designation, not returned designation, and complete designation.

6. The system of claim 1, wherein the return package includes a retail good.

7. The system of claim 1, wherein the return package excludes a fresh food product.

8. The system of claim 1, wherein the profile of the customer is stored in at least one database.

9. The system of claim 1, wherein the profile of the customer includes at least one or more previous orders.

10. The system of claim 1, wherein the at least one business rule overrides the at least rule definition.

11. A computer-implemented system for return fraud detection and prevention, the system comprising:
a memory storing instructions; and
at least one processor configured to execute the instructions to perform steps comprising:
receiving a refund request from a customer associated with an order id and a device;
associating the refund request with the order id, the device, and a content status associated with the return package;
determining the customer associated with the refund request based on the device and the content status;
aggregating a profile of the customer based on the refund request and the device;
assigning a refund status and a fraudulent member status associated with the refund request of the customer based on at least one rule definition and the profile of the customer;
determining an approval or rejection of the refund request based on the refund status, the fraudulent member status, and at least one business rule;
providing the device of the customer with the approval or rejection of the request refund;
when approval of the refund request is determined, directing a refund to be issued to the customer; and
when rejection of the refund request is determined, preventing the refund from being issued to the customer;
wherein determining the customer associated with the refund request is further based on the aggregated profile via analysis of trace identifiers or span identifiers added to data associated with communications used to generate the aggregated profile such that the customer is determined even when previous customer activity is associated with a different device, user id, name, physical address, IP address, MAC address, or communication format.

12. The system of claim 11, wherein the device includes a mobile phone, a computer, or a personal digital assistant.

13. The system of claim 11, wherein the device connects to a user interface.

14. The system of claim 11, wherein the return package includes one or more items.

15. The system of claim 11, wherein the refund request includes a fresh food product or a retail good.

16. The system of claim 11, wherein the profile of the customer is stored in at least one database.

17. The system of claim 11, wherein the profile of the customer includes at least one or more previous orders.

18. The system of claim 11, wherein the at least one business rule overrides the at least rule definition.

19. The system of claim 11, wherein the at least one business rule is the rule definition.

20. A computer-implemented method for return fraud detection and prevention, the method comprising:
receiving a refund request from a customer associated with an order id and a device;
identifying a content status associated with a return package associated with the order id and the device;
associating the refund request with the order id, the device, and the content status associated with the return package;
determining the customer associated with the refund request based on the device, and the content status;
aggregating a profile of the customer based on the refund request, the device, and the content status;
assigning a refund status and a fraudulent member status associated with the refund request of the customer based on at least one rule definition and the profile of the customer;
determining an approval or rejection of the refund request based on the refund status, the fraudulent member status, and at least one business rule;
providing the device of the customer with the approval or rejection of the request refund;
when approval of the refund request is determined, directing a refund to be issued to the customer; and
when rejection of the refund request is determined, preventing the refund from being issued to the customer;
wherein determining the customer associated with the refund request is further based on the aggregated profile via analysis of trace identifiers or span identifiers added to data associated with communications used to generate the aggregated profile such that the customer is determined even when previous customer activity is associated with a different device, user id, name, physical address, IP address, MAC address, or communication format.
